(19) United States
(12) Patent Application Publication
(10) Pub. No.: US 2021/0101777 A1
(43) Pub. Date: Apr. 8, 2021

(54) ELEVATOR BRAKE CONTROL

(71) Applicant: OTIS ELEVATOR COMPANY, Farmington, CT (US)

(72) Inventor: Steven Michael Millett, Plainville, CT (US)

(21) Appl. No.: 16/592,180

(22) Filed: Oct. 3, 2019

(51) Int. Cl. B66B 1/32; B66B 5/00; B66B 1/36

(52) U.S. Cl. CPC B66B 1/32; B66B 1/36; B66B 5/0087

(57) ABSTRACT

An illustrative example embodiment of an elevator brake control device includes at least one primary switch configured to selectively conduct current for lifting all of a plurality of brake applicators. A plurality of secondary switches are each associated with one of the brake applicators. Each of the secondary switches is configured to selectively conduct current for lifting the associated one of the brake applicators. The plurality of secondary switches are between the primary switch and the associated one of the brake applicators.

### BACKGROUND

A variety of elevator systems are known. Some elevator systems are traction-based and include roping that suspends the elevator car and a counterweight. A machine causes movement of a traction sheave that, in turn, causes movement of the roping for moving the elevator car as desired. The machine typically includes a motor and a brake that respectively cause and resist rotation of the traction sheave.

The brakes in such elevator systems typically require electrical power to lift the brake otherwise a braking force is applied by a mechanical spring to resist rotation of the traction sheave and corresponding movement of the elevator car. It has proven useful to test elevator system brakes and different approaches have been proposed. One example brake torque detection technique is described in the United States Patent Application Publication No. 2019/0031470. As the industry moves forward, changes in elevator systems and codes have introduced various challenges for controlling or testing the brakes.

### SUMMARY

An illustrative example embodiment of an elevator brake control device includes at least one primary switch configured to selectively conduct current for lifting all of a plurality of brake applicators. A plurality of secondary switches are each associated with one of the brake applicators. Each of the secondary switches is configured to selectively conduct current for lifting the associated one of the brake applicators. The plurality of secondary switches are between the primary switch and the associated one of the brake applicators.

An example embodiment having one or more features of the elevator brake control device of the previous paragraph includes a controller configured to control the at least one primary switch and the plurality of secondary switches, the controller being configured to change a state of a selected one of the secondary switches from a closed state to an open state only while the at least one primary switch is open.

In an example embodiment having one or more features of the elevator brake control device of any of the previous paragraphs, the controller is configured to open the at least one primary switch to prevent current flow to the brake applicators, open the selected one of the secondary switches while the at least one primary switch is open, and close the at least one primary switch while the selected one of the secondary switches is open.

In an example embodiment having one or more features of the elevator brake control device of any of the previous paragraphs, the controller is configured to open the at least one primary switch to prevent current flow to the brake applicators, open the selected one of the secondary switches while the at least one primary switch is open, and close the at least one primary switch while the selected one of the secondary switches is open.

In an example embodiment having one or more features of the elevator brake control device of any of the previous paragraphs, the controller is configured to determine an operation condition of the one of the brake applicators associated with the selected one of the secondary switches while the at least one primary switch is closed and the selected one of the secondary switches is open.

In an example embodiment having one or more features of the elevator brake control device of any of the previous paragraphs, the controller is further configured to open the at least one primary switch while the selected one of the secondary switches is open, close the selected one of the secondary switches while the at least one primary switch is open, open a second selected one of the secondary switches while the at least one primary switch is open, close the at least one primary switch while the second selected one of the secondary switches is open, and determine an operation condition of the one of the brake applicators associated with the second selected one of the secondary switches while the at least one primary switch is closed and the second selected one of the secondary switches is open.

An illustrative example embodiment of an elevator brake system includes: a plurality of brake applicators each configured to apply a braking force to prevent rotation of an elevator sheave in the absence of electric current being supplied to the brake applicator; at least one primary switch configured to selectively conduct current to all of the brake applicators for lifting all of the brake applicators; a plurality of secondary switches, each of the secondary switches being associated with one of the brake applicators, each of the secondary switches being configured to selectively conduct current for lifting the associated one of the brake applicators, wherein the plurality of secondary switches are between the at least one primary switch and the associated one of the brake applicators; and a controller configured to control the at least one primary switch and the plurality of secondary switches.

In an example embodiment having one or more features of the elevator brake system of the previous paragraph, the controller is configured to change a state of a selected one of the secondary switches from a closed state to an open state only while the at least one primary switch is open.

In an example embodiment having one or more features of the elevator brake system of any of the previous paragraphs, the controller is configured to open the at least one primary switch to prevent current flow to the brake applicators, open the selected one of the secondary switches while the at least one primary switch is open, and close the at least one primary switch while the selected one of the secondary switches is open.

In an example embodiment having one or more features of the elevator brake system of any of the previous paragraphs, the controller is configured to determine an operation condition of the one of the brake applicators associated with the selected one of the secondary switches while the at least one primary switch is closed and the selected one of the secondary switches is open.

In an example embodiment having one or more features of the elevator brake system of any of the previous paragraphs, the controller is further configured to open the at least one primary switch while the selected one of the secondary switches is open, close the selected one of the secondary switches while the at least one primary switch is open, open a second selected one of the secondary switches while the at least one primary switch is open, close the at least one primary switch while the second selected one of the secondary switches is open; and determine an operation condition of the one of the brake applicators associated with the second selected one of the secondary switches while the at least one primary switch is closed and the second selected one of the secondary switches is open.

In an example embodiment having one or more features of the elevator brake system of any of the previous paragraphs, the brake applicators each comprise a caliper and a sensor that provides an indication of movement of the caliper between an open and a closed condition, and the controller is configured to determine a state of each caliper based on the indication from the sensors, respectively.

An illustrative example embodiment of a method of testing an elevator brake system having a plurality of brake applicators includes: controlling a primary switch to be in a first condition in which the primary switch prevents electric current from flowing to all of the brake applicators; opening a selected secondary switch between one of the brake applicators and the primary switch while the primary switch is in the first condition; controlling the primary switch to be in a second condition in which the primary switch allows current flow to the brake applicators while the selected secondary switch is open; and determining a brake application condition of the one of the brake applicators while the selected secondary switch is open and the primary switch is in the second condition.

An example embodiment having one or more features of the method of the previous paragraph includes: controlling the primary switch to be in the first condition while the selected secondary switch is open; closing the selected secondary switch while the primary switch is in the first condition; opening a different selected secondary switch between the primary switch and a different one of the brake applicators while the primary switch is in the first condition; controlling the primary switch to be in the second condition while the second selected secondary switch is open; and determining a brake application condition of the different one of the brake applicators while the primary switch is in the second condition and the second selected secondary switch is open.

In an example embodiment having one or more features of the method of any of the previous paragraphs, the brake application condition comprises at least one of a position of the one of the brake applicators and a braking force applied by the one of the brake applicators.

In an example embodiment having one or more features of the method of any of the previous paragraphs, the brake applicators respectively comprise a caliper.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system including a brake control device designed according to an embodiment of this invention.

FIG. 2 schematically illustrates an example embodiment of an elevator machine, brake and brake control device designed according to an embodiment of this invention.

FIG. 3 is a flowchart diagram that summarizes a process for testing an elevator brake designed according to an embodiment of this invention.

### DETAILED DESCRIPTION

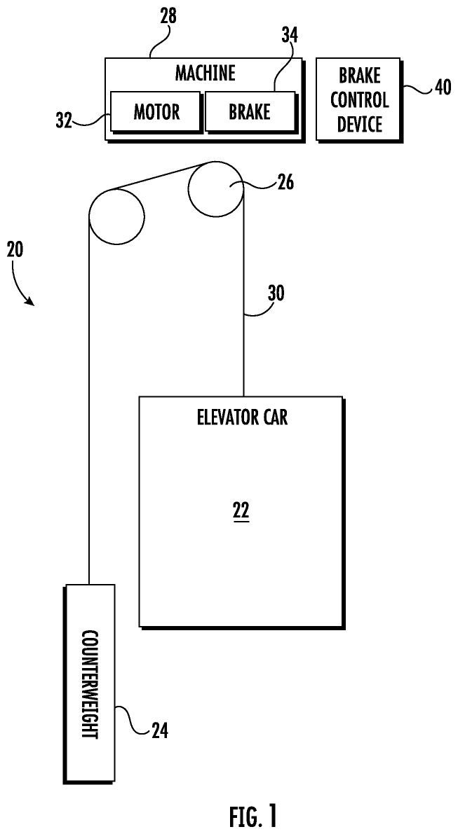

FIG. 1 schematically shows selected portions of an elevator system 20 including an elevator car 22 and counterweight 24. A traction sheave 26 associated with a machine 28 selectively controls movement of a load bearing assembly 30, which suspends the elevator car 22 and counterweight 24, to control the movement or position of the elevator car 22. The machine 28 includes a motor 32 and a brake 34. A brake control device 40 controls operation of the brake 34 under at least some circumstances.

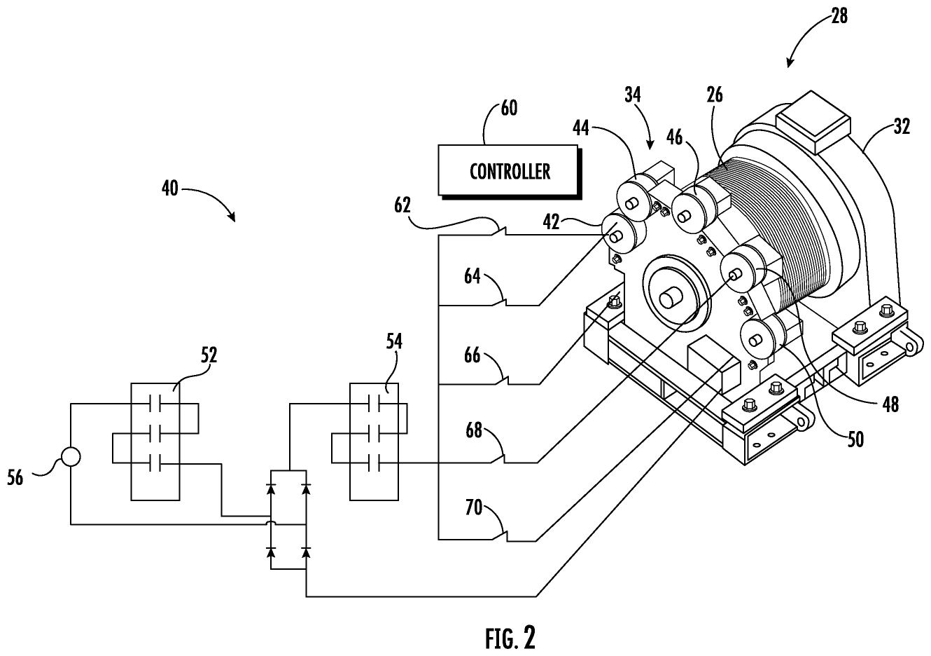

FIG. 2 schematically illustrates an example embodiment of an elevator brake system including a plurality of brake applicators 42, 44, 46, 48 and 50. In this embodiment, the brake applicators 42-50 are calipers that operate in a manner known within the elevator industry by applying a braking force in the absence of electrical power supplied to the actuators 42-50. A mechanical spring applies the brake force in the absence of electrical power. When it is desirable to move the elevator car 22, the brake applicators 42-50 use electrical power to release the braking force, which is referred to as lifting the brake.

In the embodiment of FIG. 2, the brake control device 40 includes at least one primary switch 52 that is configured for the current and voltage loads associated with operating the brake applicators 42-50. The inductive characteristics of the brake applicators 42-50 requires a sufficiently robust switch arrangement for reasons understood by those skilled in the art, such as arcing that may occur when the switch is opened.

The example embodiment of FIG. 2 includes two primary switches 52 and 54 to comply with elevator codes. The primary switches 52 and 54 selectively allow current to flow from a power source 56 to the brake applicators 42-50. During normal elevator operation for providing elevator service to passengers, the primary switches 52 and 54 operate responsive to the elevator drive (not illustrated) that controls movement of the elevator car 22. An example type of switch that is useful as the primary switch 52, 54 is a contactor switch that is rated for the conditions expected when disconnecting the brake applicators 42-50 from the power source 56.

The brake control device 40 includes a controller 60, such as a processor and associated memory, for controlling operation of the primary switches 52 and 54 at least to conduct a test of the brake applicators 42-50.

The brake control device 40 includes a plurality of secondary switches 62, 64, 66, 68 and 70 between the brake actuators 42-50 and the primary switches 52, 54. In the illustrated arrangement, each one of the secondary switches 62-70 is associated with one of the brake applicators 42-50. The controller 60 controls the secondary switches on a selective basis at least for conducting a test of the brake applicators 42-50.

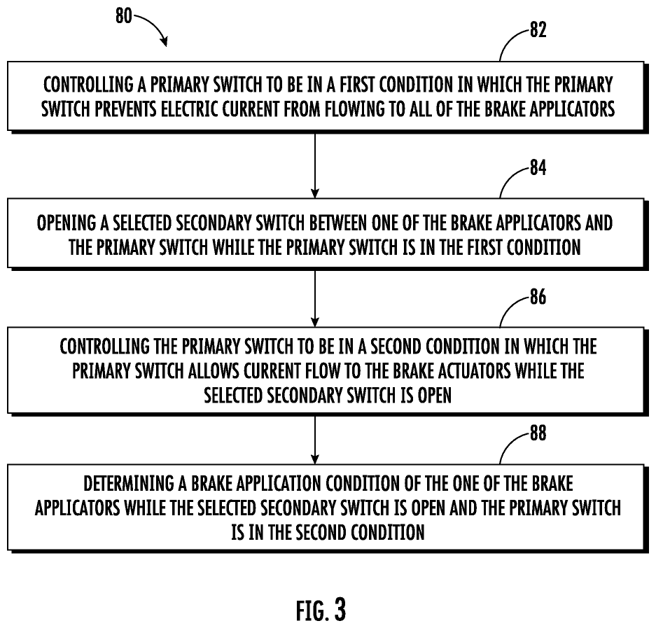

FIG. 3 is a flowchart diagram 80 that summarizes an example test procedure. At 82, the controller 60 controls the primary switches 52 and 54 to be in a first condition in which the primary switches 52 and 54 prevent electric current from flowing to all of the brake applicators 42-50. In the first condition, the primary switches 52 and 54 are open or otherwise non-conducting. Given the location of the secondary switches 62-70, no current flows through any of them when the primary switches 52, 54 are in the first condition.

At 84, the controller 60 opens at least one selected secondary switch, such as the secondary switch 62, while the primary switches 52 and 54 are in the first condition.

At 86, the controller 60 controls the primary switches 52 and 54 to be in a second condition in which the primary switches 52 and 54 allow current flow to the brake applicators 42-50 while the selected secondary switch is open. Since the secondary switch 62 is open in this example scenario, no current flows to the brake applicator 42 when the primary switches 52 and 54 are placed in the second condition to allow current flow through them. The second condition includes the primary switches 52 and 54 being closed or otherwise allowing for current flow.

With the primary switches 52 and 54 in the second condition and the secondary switch 62 open while the other secondary switches 64-70 are closed, current flows to the brake applicators 44-50 releasing the braking force of each of those brake applicators. Only the brake applicator 42 applies a braking force under those circumstances.

At 88, the controller 60 determines a brake application condition of the brake applicators 42-50 while the secondary switch 62 is open and the primary switches 52 and 54 are in the second condition. In this example scenario, the brake applicator 42 is expected to be applying a braking force and the others are expected to be lifted. The brake application condition determined by the controller at 88 may include movement or position of the components of each brake applicator 42-50 (e.g., an open or closed position), and any other feature of interest for a particular installation. The brake applicators 42-50 each include at least one sensor that provides an indication to the controller 60 regarding the brake application condition.

Since the secondary switch 62 is open and the brake applicator 42 should be applying a braking force, the brake application condition determination at 88 may include the elevator drive applying a selected level of torque to the elevator motor 32 so that velocity or position feedback information provides an indication if the brake applicator 42 is able to prevent rotation at that torque level.

The controller 60 subsequently controls the primary switches 52 and 54 to return to the first condition so that no power is supplied to the brake applicators 42-50. The secondary switch 62 can then be closed and the controller 60 can open any other one or more of the secondary switches for purposes of testing another one of the brake applicators.

The location of the secondary switches 62-70 between the primary switches 52 and 54 and the brake applicators 42-50 allows for testing the individual brake applicators. The secondary switches 62-70 may be much less robust compared to the primary switches 52 and 54. This allows for including the capability of testing the individual brake applicators 42-50 without requiring multiple sets of primary switches, which are more expensive. By selectively opening or closing the secondary switches 62-70 only when no power is provided to the brake applicators and the primary switches 52 and 54 are in the first condition allows for using less expensive secondary switches and providing individualized brake applicator testing capability. Since no power is supplied to the brake applicators 42-50 when the primary switches 52 and 54 are open or in the first condition, the secondary switches 62-70 are not exposed to the arcing conditions that otherwise would occur if current was being supplied to the brake applicators 42-50 at the time that a secondary switch was being opened.

Given the manner in which power supply through the primary switches 52 and 54 is controlled, the secondary switches 62-70 may be, for example, relay switches, semiconductor switches, or contactor switches that are less robust and less expensive than the type of contactor switches used as the primary switches 52 and 54.

Depending on the selection of secondary switches 62-70, the controller 60 is configured in some embodiments to perform dynamic testing of more than one of the brake applicators 42-50 at a particular time. Although testing a single brake applicator is described above, some embodiments include testing more than one brake applicator at the same time.

Although the controller 60 is schematically shown in FIG. 2 as a device or component that is distinct from the elevator drive, some embodiments include incorporating the features and capability of the example controller 60 into the elevator drive.

The disclosed example embodiment provides the capability of testing individual brake applicators in an elevator brake system without introducing an additional primary switch for each of the brake applicators and incurring the additional cost associated with duplicating primary switch capability. The strategic position of the secondary switches 62-70 and the strategic control over when those switches are opened or closed provides an effective, reliable and economical way to individually test multiple brake applicators in an elevator brake system.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. An elevator brake control device for controlling an elevator brake including a plurality of brake applicators, the brake control device comprising:
at least one primary switch configured to selectively conduct current for lifting all of the brake applicators; and
a plurality of secondary switches, each of the secondary switches being associated with one of the brake applicators, each of the secondary switches being configured to selectively conduct current for lifting the associated one of the brake applicators, wherein the plurality of secondary switches are between the at least one primary switch and the associated one of the brake applicators.

2. The elevator brake control device of claim 1, comprising a controller configured to control the at least one primary switch and the plurality of secondary switches, the controller being configured to change a state of a selected one of the secondary switches from a closed state to an open state only while the at least one primary switch is open.

3. The elevator brake control device of claim 2, wherein the controller is configured to
open the at least one primary switch to prevent current flow to the brake applicators;
open the selected one of the secondary switches while the at least one primary switch is open; and
close the at least one primary switch while the selected one of the secondary switches is open.

4. The elevator brake control device of claim 3, wherein the controller is configured to
determine an operation condition of the one of the brake applicators associated with the selected one of the secondary switches while the at least one primary switch is closed and the selected one of the secondary switches is open.

5. The elevator brake control device of claim 3, wherein the controller is further configured to
open the at least one primary switch while the selected one of the secondary switches is open;
close the selected one of the secondary switches while the at least one primary switch is open;
open a second selected one of the secondary switches while the at least one primary switch is open;
close the at least one primary switch while the second selected one of the secondary switches is open; and
determine an operation condition of the one of the brake applicators associated with the second selected one of the secondary switches while the at least one primary switch is closed and the second selected one of the secondary switches is open.

6. An elevator brake system, comprising:
a plurality of brake applicators each configured to apply a braking force to prevent rotation of an elevator sheave in the absence of electric current being supplied to the brake applicator;
at least one primary switch configured to selectively conduct current to all of the brake applicators for lifting all of the brake applicators;
a plurality of secondary switches, each of the secondary switches being associated with one of the brake applicators, each of the secondary switches being configured to selectively conduct current for lifting the associated one of the brake applicators, wherein the plurality of secondary switches are between the at least one primary switch and the associated one of the brake applicators; and
a controller configured to control the at least one primary switch and the plurality of secondary switches.

7. The elevator brake system of claim 6, wherein the controller is configured to change a state of a selected one of the secondary switches from a closed state to an open state only while the at least one primary switch is open.

8. The elevator brake system of claim 7, wherein the controller is configured to
open the at least one primary switch to prevent current flow to the brake applicators;
open the selected one of the secondary switches while the at least one primary switch is open; and
close the at least one primary switch while the selected one of the secondary switches is open.

9. The elevator brake system of claim 8, wherein the controller is configured to
determine an operation condition of the one of the brake applicators associated with the selected one of the secondary switches while the at least one primary switch is closed and the selected one of the secondary switches is open.

10. The elevator brake system of claim 8, wherein the controller is further configured to
open the at least one primary switch while the selected one of the secondary switches is open;
close the selected one of the secondary switches while the at least one primary switch is open;
open a second selected one of the secondary switches while the at least one primary switch is open;
close the at least one primary switch while the second selected one of the secondary switches is open; and
determine an operation condition of the one of the brake applicators associated with the second selected one of the secondary switches while the at least one primary switch is closed and the second selected one of the secondary switches is open.

11. The elevator brake system of claim 6, wherein
the brake applicators each comprise a caliper and a sensor that provides an indication of movement of the caliper between an open and a closed condition; and
the controller is configured to determine a state of each caliper based on the indication from the sensors, respectively.

12. A method of testing an elevator brake system that includes a plurality of brake applicators, the method comprising:
controlling a primary switch to be in a first condition in which the primary switch prevents electric current from flowing to all of the brake applicators;
opening a selected secondary switch between one of the brake applicators and the primary switch while the primary switch is in the first condition;
controlling the primary switch to be in a second condition in which the primary switch allows current flow to the brake applicators while the selected secondary switch is open; and
determining a brake application condition of the one of the brake applicators while the selected secondary switch is open and the primary switch is in the second condition.

13. The method of claim 12, comprising
controlling the primary switch to be in the first condition while the selected secondary switch is open;
closing the selected secondary switch while the primary switch is in the first condition;
opening a different selected secondary switch between the primary switch and a different one of the brake applicators while the primary switch is in the first condition;
controlling the primary switch to be in the second condition while the second selected secondary switch is open; and
determining a brake application condition of the different one of the brake applicators while the primary switch is in the second condition and the second selected secondary switch is open.

14. The method of claim 12, wherein the brake application condition comprises at least one of a position of the one of the brake applicators and a braking force applied by the one of the brake applicators.

15. The method of claim 14, wherein the brake applicators respectively comprise a caliper.
